(19) United States
(12) Patent Application Publication
(10) Pub. No.: US 2014/0154644 A1
(43) Pub. Date: Jun. 5, 2014

(54) METHOD AND APPARATUS FOR PREPARING DENTURE

(71) Applicant: DENTCA, Inc., Los Angeles, CA (US)

(72) Inventors: Tae Hyung KIM, La Canada, CA (US); Sun KWON, Arcadia, CA (US)

(73) Assignee: DENTCA, INC., Los Angeles, CA (US)

(21) Appl. No.: 14/172,689

(22) Filed: Feb. 4, 2014

Related U.S. Application Data
(63) Continuation-in-part of application No. 13/598,413, filed on Aug. 29, 2012.
Application No. 13/598,413 is a continuation of application No. 12/782,663, filed on May 18, 2010, now Pat. No. 8,277,216.
(60) Provisional application No. 61/868,038, filed on Aug. 20, 2013.
(60) Provisional application No. 61/179,698, filed on May 19, 2009.

(51) Int. Cl. A61C 9/00; A61C 13/01

(52) U.S. Cl. CPC A61C 9/0006; A61C 13/01
USPC 433/214

(57) ABSTRACT

A dental tracing apparatus including a first layer having a first surface and a second surface coated with an adhesive material; a second layer over the first surface, an edge portion of the second layer being substantially firmly attached to an edge portion of the first surface; and a removable third layer over the second surface of the first layer. The dental tracing apparatus is sized and shaped to be attached to a surface of a dental tray after the third layer is removed. The dental tracing apparatus receives tracing caused by an object via the second layer such that the tracing is marked on the dental tracing apparatus. The marked tracing is removable by separating the second layer from the first surface of the first layer and the lifted second layer is repositionable on the first surface of the first layer to receive further tracing.

### CROSS REFERENCE TO RELATED APPLICATIONS

Pursuant to 35 U.S.C. §119(e), this application claims the benefit of U.S. Provisional Application No. 61/868,038, filed on Aug. 20, 2013 and this is a continuation-in-part of U.S. patent application Ser. No. 13/598,413, filed on Aug. 29, 2012, currently pending, which is a continuation of U.S. patent application Ser. No. 12/782,663, filed on May 18, 2010, now U.S. Pat. No. 8,277,216, which pursuant to 35 U.S.C. §119(e) claims the benefit of U.S. Provisional Application No. 61/179,698, filed on May 19, 2009, the contents of which are all hereby incorporated by reference herein in their entirety.

### FIELD OF THE INVENTION

The present disclosure relates generally to dentures, and more particularly to a simplified method and apparatus for fabricating dentures. In particular, the present invention is directed to a dental tracer for recording a centric relation (CR). The inventive dental tracer is used with a dental impression tray to provide an easy and accurate method for measuring and recording CR.

### DESCRIPTION OF THE RELATED ART

Dentures are conventionally constructed and fitted by dentists with the assistance of dental technicians using a flask investment technique. This complex process requires measurements of masticatory function, impressions of the gum and surrounding tissues of the affected area, study models and working models, and a series of back and forth steps between the dentist and the dental technician to manufacture the denture. The entire process of constructing dentures using conventional methods and devices requires a number of appointments between the dentist and the patient, and involves a significant amount of time and skill.

Generally, a patient must make a plurality of visits to a dentist to make a set of dentures. Such visits are necessary in order for a dentist to take an impression of the patient's gums, as well as a bite registration of the patient's jaw position and vertical dimension. Information collected during the conventional multiple patient visit procedure includes finding an accurate shape of edentulous ridges, bite registration of the patient's jaw position and vertical dimension, ideal teeth set-up for the patient, and necessary adjustments regarding fit and occlusion.

For example, during a first visit, a dentist examines a patient and takes a preliminary impression of the patient using stock impression trays. After the preliminary impression is taken on the impression material, the impression tray is delivered to a laboratory. In the laboratory, plaster is poured onto the preliminary impression to form accurate models of the shape of the edentulous ridges. The preliminary impression is used to make custom fitting impression trays for a final impression.

During a second visit, the dentist checks and adjusts the custom fitting impression trays as necessary and takes the final impression. Afterwards, in the laboratory, a master model is created and a base plate is fabricated based on the final impression received from the dentist. Then, a bite registration rim or block, usually made of wax, is fabricated from the master gum mold. The master gum mold, with the bite registration rim attached thereto, is sent back to the dentist.

During a third visit, the bite registration rim is inserted into the mouth of the patient, and adjusted inside the mouth to determine maxilla-mandibular relations and to take a bite registration. Further, artificial teeth to be used for the denture are selected by the dentist and the patient by determining a gum shade, teeth size, and teeth shade. The adjusted bite registration rim is sent back to the laboratory to fabricate a wax try-in. The laboratory returns the wax try-in with the actual final teeth lined up along the outer edge of the wax rim. The wax try-in looks similar to a real denture except that the base fits loosely on the gums and the teeth are embedded in wax instead of plastic.

During a fourth visit, the dentist examines how the wax try-in looks and works in the patient, checking occlusal and vertical dimension, necessary adjustments of the try-in being made as necessary. If adjustments are necessary, the wax try-in can be sent back to the laboratory to reset the teeth. If no adjustments are needed, the wax try-in is sent back to the laboratory to be processed and finished. In the laboratory, the wax try-in is converted to a final denture using plastic molding.

During a fifth visit, the final denture is inserted into the mouth of the patient and adjusted as needed. The final denture is also checked for occlusion and corrected as necessary. Occlusion means simply the contact between teeth. More technically, it is the relationship between the maxillary (upper) and mandibular (lower) teeth when they approach each other, as occurs during chewing or at rest. As discussed above, it may generally take at least four or more visits of a patient until the finished dentures are finally inserted into the mouth of the patient. Thus, the multi-step process of preparing a set of dentures, requiring several iterations between the dentist and the dental laboratory is time-consuming, labor intensive and costly.

Moreover, difficulties exist in producing a good quality denture due to the great diversity in sizes and shapes of patients' mouths, and facial features requiring custom fabrication of each denture. Thus, standardization of prefabricated dentures is very difficult. Proposals to overcome the shortcomings of the conventional methods, such as multiple visits, intensive labor, and laboratory time needed for the fabrication of dentures, have had little success.

Therefore, it is critical to get all the necessary information involving the patient mouth on the first visit in order to reduce the number of total visits, and to generate final dentures without compromising quality. Conventional impression trays have difficulties capturing the jaw relation because the tray must be inserted in the patient mouth in order to measure the jaw relation, and the end portions of the upper and lower trays contact each other at the posterior position of the mouth to create interference due to their sizes. Alternatively, jaw relations are measured using other tools and by taking another impression from first visit.

Therefore, it is desirable to provide alternative dental tracing instruments and methods for obtaining centric relations to reduce the number of visits needed for denture production. It is further desirable to provide dental tracing instruments and methods for removable dentures that enable multiple measurement methods including Gothic arch tracing, simplified tracing, direct check bite capture, and/or any other tracing method used in the dental field.

### SUMMARY OF THE INVENTION

The present invention overcomes all of the aforementioned shortcomings by providing a dental apparatus that is convenient to manipulate and software that allows accurate manufacturing of a complete denture without intensive manual labor. The present invention reduces the number of patient visits, cost and time conventionally required to produce a custom denture.

In accordance with one exemplary embodiment of the present invention, a dental tracing apparatus includes a first layer having a first surface and a second surface, wherein the second surface is coated with an adhesive material; a second layer over the first surface of the first layer, wherein an edge portion of the second layer is substantially firmly attached to an edge portion of the first surface such that the second layer can be lifted off the first surface while the edge portion of the second layer is attached to the first surface; and a removable third layer over the second surface of the first layer. In one aspect, the dental tracing apparatus is sized and shaped to be attached to a surface of a dental tray that is insertable into a mouth of a subject after the third layer is separated from the second surface of the first layer. In another aspect, the dental tracing apparatus is configured to receive first tracing by an object via the second layer such that the first tracing generated according to movement of the object is marked on the dental tracing apparatus. In yet another aspect, the marked first tracing is removable by separating the second layer from the first surface of the first layer; and the lifted second layer is repositionable on the first surface of the first layer to receive second tracing by the object.

In accordance with another exemplary embodiment of the present invention, a dental impression tray assembly kit includes an upper tray configured to receive impression material for taking a first impression of a patient's gum and sized to be inserted into the patient's mouth; a lower tray including a first piece configured to receive impression material for taking a second impression of the patient's gum and sized to be inserted into the patient's mouth, wherein the first piece is curved at about a central portion to form a right end portion and a left end portion; and a pair of second pieces detachably coupled to the first piece, a right piece of the pair of second pieces coupled to the right end portion of the first piece and a left piece of the pair of second pieces coupled to the left end portion of the first piece; and a dental tracing apparatus comprising three layers.

In accordance with yet another exemplary embodiment of the present invention, a dental impression tray assembly includes a lower tray including a first piece and a pair of second pieces detachably coupled to the first piece, wherein the first piece includes a receiving structure and the pair of second pieces are shaped to fit over the patient's lower gum when the pair of second pieces are coupled to the first piece; an upper tray including a third piece and a fourth piece configured to be detachably coupled to the third piece, wherein the third piece and the fourth piece are configured to be coupled and inserted together into a mouth of the patient; an intra-oral tracer that is configured to be detachably coupled to the first piece of the lower tray via the receiving structure; and a dental tracing apparatus including a first layer having a first surface and a second surface, wherein the second surface is coated with an adhesive material; a second layer over the first surface of the first layer, wherein an edge portion of the second layer is substantially firmly attached to an edge portion of the first surface such that the second layer can be separated from the first surface while the edge portion of the second layer is attached to the first surface; and a removable third layer over the second surface of the first layer. In one aspect, the dental tracing apparatus is attached to a bottom surface of the third piece of the upper tray via the second surface of the first layer after the third layer is removed from the dental tracing apparatus. In another aspect, the intra-oral tracer is shaped to form a hole at a middle portion and an adjustable member is inserted into the hole to be raised or lowered through the hole to determine a vertical dimension. In yet another aspect, an upper end of the adjustable member is configured to contact the second layer of the dental tracing apparatus over the first surface of the first layer when the third piece and the first piece with the intra-oral tracer attached thereto are inserted into the mouth together such that a centric relation is recorded on the dental tracing apparatus according to movement of the adjustable member in the mouth. In further aspect, the first piece of the lower tray is sized to cover an anterior portion of the patient's lower gum and the pair of second pieces are sized to cover distal portions or the rest of the lower gum when attached to the first piece such that a size of the lower tray including the first piece and the pair of second pieces is fixed.

These and other embodiments will also become readily apparent to those skilled in the art from the following detailed description of the embodiments having reference to the attached figures, the invention not being limited to any particular embodiment disclose.

### BRIEF DESCRIPTION OF THE DRAWINGS

The above and other aspects, features, and advantages of the present invention will become more apparent upon consideration of the following description of preferred embodiments, taken in conjunction with the accompanying drawings.

FIG. 1A is a top view of an upper tray according to an embodiment of the present invention, the upper tray comprising a first piece and a second piece where the first piece and the second piece are separated. FIG. 1B is a top view of the upper tray where the first piece and the second piece are detachably coupled. FIG. 1C is a disassembled perspective view of the upper tray. FIG. 1D is an assembled perspective view of the upper tray.

FIG. 2A is a top view of a lower tray according to an embodiment of the present invention, the lower tray comprising a third piece and a pair of fourth pieces where the third piece and the pair of fourth pieces are separated. FIG. 2B is a perspective view of the lower tray in which the third piece and the pair of fourth pieces are detachably coupled. FIG. 2C is a bottom view of the lower tray in which the third piece and the pair of fourth pieces are detachably coupled.

FIG. 3A is a top view of the assembled lower tray to which an intra-oral tracer is attached according to an embodiment of the present invention. FIG. 3B is a perspective view of the assembled lower tray to which the intra-oral tracer is attached.

FIG. 4 is a bottom view of the assembled upper tray showing a portion on which a dental tracer according to an embodiment of the present invention is to be applied.

FIG. 5A is a frontal view of the first piece of the upper tray and the third piece of the lower tray with the intra-oral tracer attached thereto, the intra-oral tracer contacting a bottom surface of the first piece. FIG. 5B is a side view of the first piece of the upper tray and the third piece of the lower tray with the intra-oral tracer attached thereto, the intra-oral tracer contacting the bottom surface of the first piece.

FIG. 6 is a perspective view of a dental tracer according to an embodiment of the present invention.

FIG. 7 is a perspective view of a dental tracer applied to a bottom surface of the upper tray according to an embodiment of the present invention. FIG. 7 also illustrates recording CR using the dental tracer and a pin of the intra-oral tracer attached to the lower tray according to an embodiment of the present invention.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

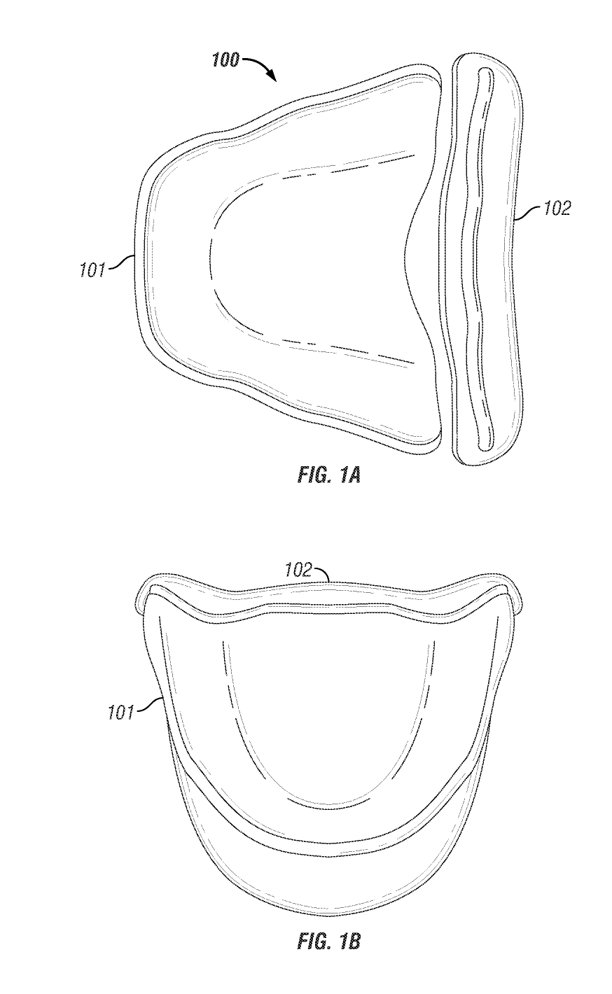

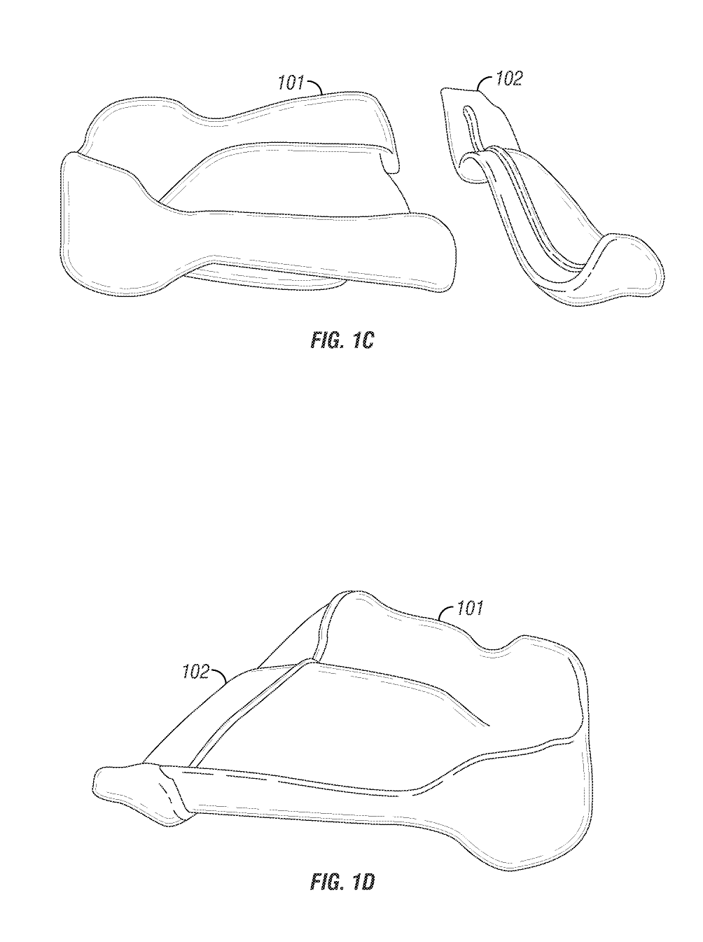

According to an embodiment of the present invention, the inventive set of trays, including an upper (maxillary) tray 100 and a lower (mandibular) tray 200, are capable of measuring jaw relations and taking a final impression in a single visit. The set of trays 100 and 200 may be made of plastic and may be available in various sizes to accommodate different sizes of jaws. The set of trays 100 and 200 may include a plurality of pieces or portions that can be assembled or disassembled. The upper tray 100 includes two pieces 101 and 102 as shown in FIGS. 1A-1D. The lower tray 200 includes a plurality of pieces 201 and 202 as shown in FIGS. 2A-2B to be accommodated in a mouth of a patient.

The upper tray 100 and the lower tray 200, as shown in FIGS. 1A-1D and FIGS. 2A-2B, respectively, are used individually to take a maxillary (upper) impression and a mandibular (lower) impression, respectively. When the maxillary impression is taken using the upper tray 100, the upper tray 100, including both the first piece 101 and the second piece 102, is inserted into the patient's mouth. Further, when the mandibular impression is taken using the lower tray 200, the lower tray 200, including both the third piece 201 and the pair of fourth pieces 202, is inserted into the patient's mouth. For example, a polymer material, such as polyvinyl siloxane (PVS), is loaded on the first piece 101 and the second piece 102 of the upper tray 100, and the upper tray 100 retaining the polymer material is inserted into the mouth to obtain the maxillary impression of a patient's gum. Specifically, the polymer material is loaded on an upper surface of the upper tray 100. Similarly, the polymer material is loaded on the third piece 201 and the pair of fourth pieces 202 of the lower tray 200, and the lower tray 200 retaining the polymer material on its lower surface is inserted into the mouth to obtain the mandibular impression of the patient's gum.

While the polymer material is still on the upper tray 100, the polymer material is cut, substantially along a single line or borderline where the first piece 101 and second piece 102 meet. For example, a surgical blade may be used to cut the polymer material on the upper tray 100. Once the polymer material on the upper tray 100 is cut completely, the first piece 101 and the second piece 102 containing the respective cut polymer material are separated carefully. Excess impression (polymer) material covering outer surfaces of the first piece 101 and the second piece 102 may be trimmed so that bite registration material can be seated. Similarly, the polymer material on the lower tray 200 is cut substantially along a single line between the third piece 201 and the pair of fourth pieces 202. Once the polymer material on the lower tray 200 is cut completely, the pair of fourth pieces 202 are separated from the third piece 201.

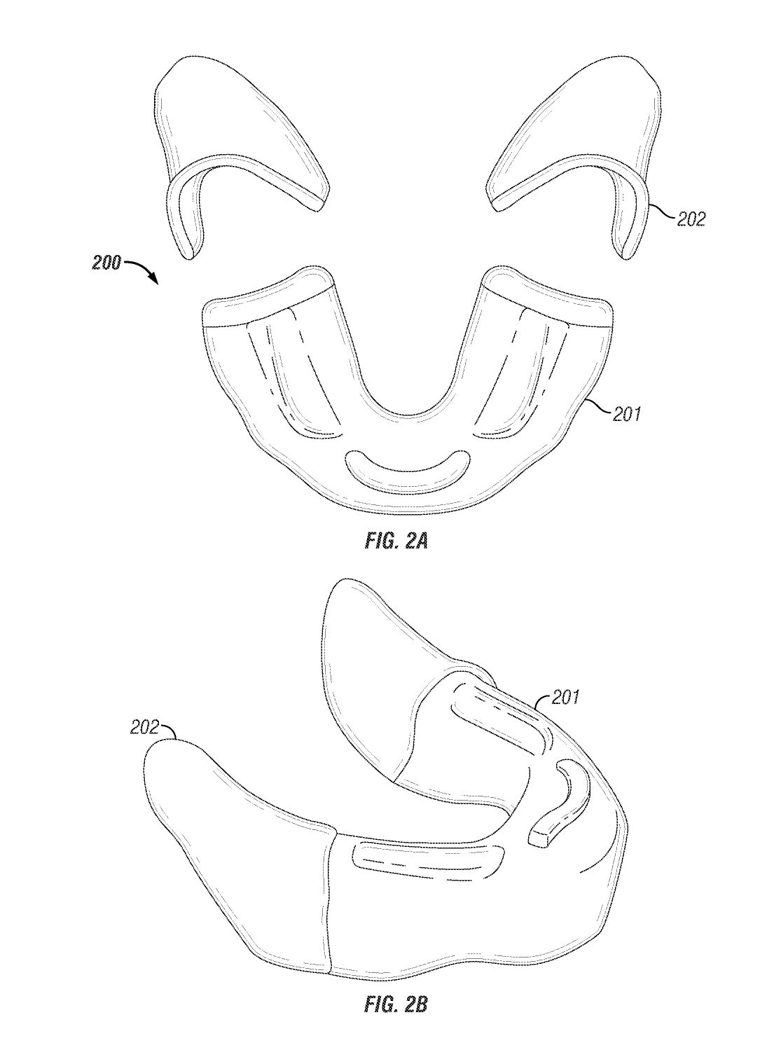

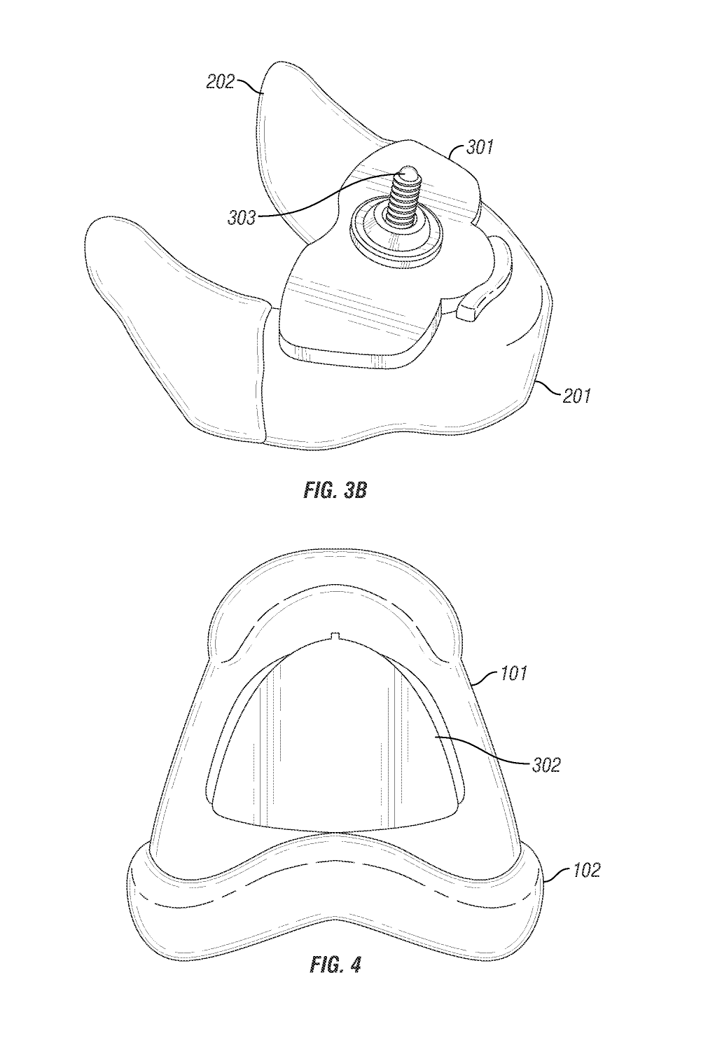

Thereafter, the first piece 101 and the third piece 201 retaining the partial impression (polymer material) are inserted into the mouth together with an intra-oral tracer 301 attached to the third piece 201 as shown in FIGS. 5A and 5B. The intra-oral tracer 301 is shaped to receive a pin 303 at a substantially central area of the intra-oral tracer 301, as shown in FIGS. 3A, 3B, 5A, and 5B. For example, the pin 303 may be formed as a screw and the screw is inserted into a screw hole formed at the substantially central area or at a middle portion of the intra-oral tracer 301 such that the pin 303 can be raised or lowered by rotating the pin 303 through the screw hole. Preferably, the pin 303 has at least one tip having a pointed end. More preferably, the tip of the pin 303 directed upward toward the first piece 101 has a pointed end.

The intra-oral tracer 301 is inserted into a receiving portion formed at an upper surface of the third piece 201 of the lower tray 200, as shown in FIGS. 3A and 3B, to be inserted into the mouth, the upper surface of the third piece 201 being a surface that is opposite to a surface of the third piece 201 retaining the impression. The receiving portion of the third piece 201 may be formed as a slot at an upper inner surface of the third piece 201 such that edge portions of the intra-oral tracer 301 are inserted to the slot. In one embodiment, two slots are formed at an upper inner side surface of the third piece 201, the two slots facing each other such that one side edge of the intra-oral tracer 301 is inserted into one slot and the other side edge of the intra-oral tracer 301 is inserted into the other slot.

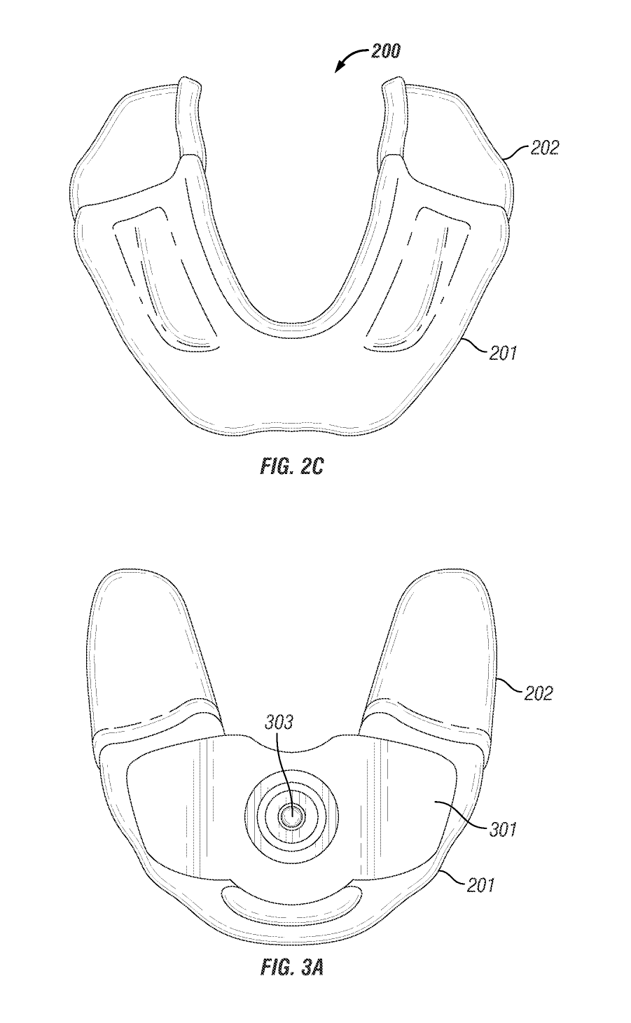

Further, a cover 302 may be placed on a lower surface of the first piece 101 of the upper tray 100 as shown in FIG. 4. Alternatively, as shown in FIGS. 1A-1D, the upper tray 100 may not need a separate cover that needs to be manually placed. A tracing material is applied to the first piece 101 of the upper tray 100 such that the pin 303 of the intra-oral tracer 301 contacts the applied tracing material when the first piece 101 and the third piece 201 are inserted into the mouth together with the intra-oral tracer 301 attached to the third piece 201, as shown in FIGS. 5A and 5B, to measure jaw relations such as a vertical dimension (VD) and a centric relation (CR).

When the upper tray 100 and the lower tray 200 are inserted into the mouth together, the second piece 102 and the pair of fourth pieces 202 are not attached to the first piece 101 and the third piece 201, respectively, because both the first piece 101 and the third piece 201 are sized to be placed together in a patient's mouth without the second piece 102 and the pair of fourth pieces 202. Further, if the pin 303 of the intra-oral tracer 301 has a tip with the pointed end, the tip with the pointed end is directed upward to contact the tracing material applied to the first piece 101 in the mouth. For example, see FIGS. 3A-3B, 5A-5B, and 7.

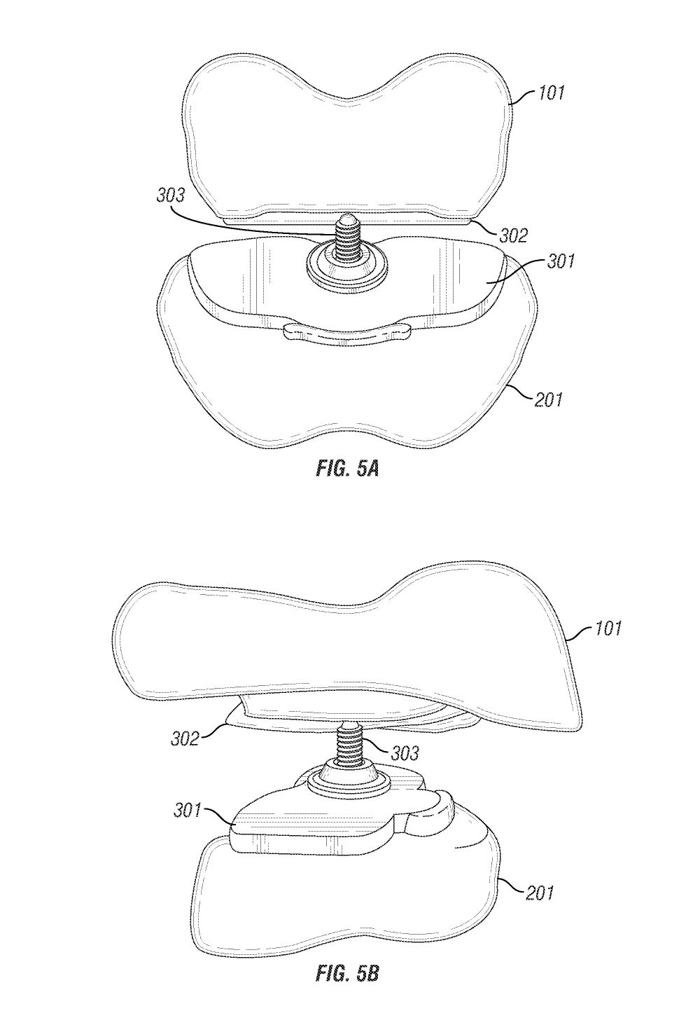

In one embodiment, the tracing material is a dental tracer 600 including three layers 601, 602, 603 as shown in FIG. 6. The tracer 600 may further include a wrapper placed on an edge portion of the tracer 600 to hold the three layers 601, 602, 603 together. The inventive dental tracer 600 is quite different from conventional tracing materials used in dental procedures, such as a permanent marker, a wax crayon, or a lipstick, and it is very easy and convenient to use compared to the conventional tracing materials.

Referring to FIG. 6, a first layer 602 of the tracer 600 has a first surface that is in contact with a second layer 601 and a second surface that is in contact with a third layer 603. In one embodiment, the first surface of the first layer 602 is colored, preferably dark colored or black, and the second layer 601 is a semi-transparent film such that the first surface is visible through the second layer 601. The second layer 601 has an edge portion that is substantially firmly attached to an edge portion of the first layer 602 such that the rest of the second layer 601 is merely placed on the first surface of the first layer 601 and the second layer 601 can be lifted off the first surface while the edge portion of the second layer 601 remains attached to the edge portion of the first layer 602. For example, the edge portion of the second layer 601 and the edge portion of the first layer 602 are coupled by an adhesive material that is applied to at least one of the edge portions. When an object contacts and moves on the second layer 601 that is in contact with the first surface of the first layer 602, the movement of the object is traced such that a tracing mark is visible on the dental tracer 600. Thereafter, when the second layer 601 is separated from the first surface of the first layer 602, the tracing mark is removed. Therefore, tracing can be repeated as desired using the inventive dental tracer 600.

In one embodiment, the second surface of the first layer 602 is adhesive and the third layer 603 is a peelable protecting cover that adheres to the second surface of the first layer 602. For example, the third layer 603 may be formed from paper and when the third layer 603 is peeled off or removed, the adhesive second surface of the first layer 602 is exposed to be applied to a target surface. When the dental tracer 600 is applied and attached to the target surface via the second surface of the first layer 602, the second layer 601 remains on the first surface of the first layer 602, allowing tracing on the second layer 601 by an object.

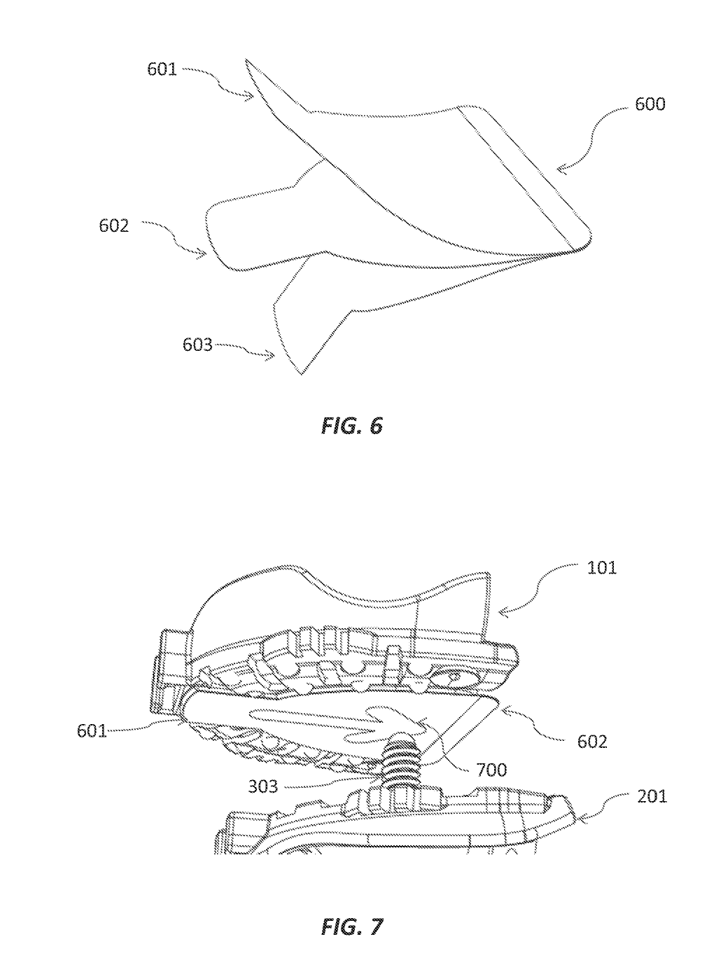

The dental tracer 600 may be used with any impression trays used for preparation of dentures. The dental tracer 600 is sized to fit on a surface of an upper tray that is inserted into a patient's mouth. For example, after the third layer 603 is peeled off, the dental tracer 600 is applied to the cover 302 or a portion of the lower surface of the first piece 101 that corresponds to the cover 302, if there is no separate cover for the first piece 101, via the second surface of the first layer 602, as shown in FIG. 7. Then, the first piece 101 with the dental tracer 600 applied thereon is inserted into the mouth along with the third piece 201 with the intra-oral tracer 301 attached thereto.

Jaw relations are measured by lowering or raising the pin 303 of the intra-oral tracer 301 that is in contact with the first piece 101 in the mouth until patient's lips naturally touch each other without the lips having any tension. Once the intra-oral tracer 301 is adjusted to be in a clinically acceptable position, the vertical dimension is measured and the centric relation is determined by having the patient move his/her jaw front and back several times to capture the most posterior position. When the first piece 101 and the third piece 201 are in the mouth to determine the centric relation, the pointed end of the pin 303 is directed upward, thus contacting the second layer 601 of the dental tracer 600 attached to the first piece 101, as shown in FIG. 7. Therefore, when the patient's jaw is moved, the centric relation is traced according to movement of the pin 303 and the tracing marking 700 generated according to the movement of the pin 303 is visible on the dental tracer 600 through the second layer 601, as shown in FIG. 7.

For example, the patient's lower jaw is guided forward and backward to the most posterior position and then laterally in both directions from the most posterior position to find the optimal centric relation using the intraoral gothic arch tracing method. The dental tracer 600 can be used for other tracing methods as well, including simplified tracing (moving the mandible from anterior to posterior multiple times to find the most posterior point) direct check bite (having the patient bite down multiple times while holding the mandible in the most posterior position) and other tracing methods involving impression trays. If the centric relation is not captured properly, the second layer 601 is lifted from the dental tracer 600 to clear the markings and tracing can be repeated using the same dental tracer 600 until a desirable outcome is achieved.

After determining the centric relation position, a dimple is drilled at the centric relation position and the pin 303 is locked in to the dimple. Thereafter, a polymer material is filled in between the first piece 101 and the third piece 201 to obtain a bite registration. After the polymer material is filled to obtain the bite registration, the entire piece, including the first piece 101 and the third piece 201, is removed from the patient's mouth.

In order to measure the jaw relation record and record the centric relation, the mouth of the patient needs to be able to accommodate the trays when they are inserted into the mouth. However, if full-sized trays, such as conventional trays, are inserted into the mouth, it is difficult for the patient's mouth to accommodate the full-sized conventional trays because the end portions of the upper and lower trays contact each other at the posterior position of the mouth, thus becoming very bulky in the mouth. In order to solve this problem, the trays of the present invention have been sized to be accommodated in the mouth. For example, the dissembled trays, or a full sized upper tray and the dissembled lower tray, cover at least an anterior position of the mouth while not covering the entire region of the mouth. Therefore, according to the present example, jaw relations can be measured after obtaining the full impression of the patient's gum first using the full-sized upper tray 100 and the lower tray 200 individually, and then by cutting the obtained impression and separating the first piece 101 and the second piece 102 of the upper tray 100 and separating the third piece 201 and the pair of fourth pieces 202 of the lower tray 200.

The shapes of the trays have unique dimensions, the first piece 101 providing the position of the tray and the third piece 201 supporting the borders and capturing muscle movements. The first and third pieces 101 and 201 may have openings to retain the impression material.

According to another embodiment of the present invention, software is used to obtain a virtual model of the denture to be fabricated. From the scanned data of the PVS impression of the upper and lower trays 100 and 200, a three-dimensional (3-D) model is generated in a computer. The inventive software is used to fabricate dentures by taking the measurements of edentulous regions of the maxilla and mandible from the respective impressions. Further, information on the VD and CR obtained by using the inventive tray assembly is input into the software to create the dentures. The software synthesizes all the data and creates a 3-D model of the edentulous ridge and generates the placement of the teeth and gingival tissue. Included in the software are various sets of teeth types, varying based on shape, size and color. After selecting a desired tooth type, the software automatically generates a denture with the above discussed three reference points to correctly place the teeth. Furthermore, the software corrects any overlap of tooth structure that may arise from a discrepancy between the selected tooth type and the measurements entered from the impressions and gathered data. Once the virtual denture is created, the software will export the file to allow fabrication of the custom denture.

Various embodiments described herein may be implemented in a computer-readable medium, a machine-readable medium, or similar medium using, for example, software, hardware, or any combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof.

For a software implementation, certain embodiments described herein may be implemented with separate software modules, such as procedures and functions, each of which perform one or more of the functions and operations described herein. The software codes can be implemented with a software application written in any suitable programming language and may be stored in memory, and executed by a controller or processor.

According to yet another embodiment of the present invention, the final denture is milled based on the above described information. Upon receiving the file of the virtual denture generated by the software, a machine will mill an acrylic block into the real denture. The milling denture comprises two different pieces. The first piece is on the teeth portion, and the second piece is on the gingival portion. Each piece is milled separately, and after milling, the two pieces are put together to form the denture.

Alternatively, the denture may be fabricated by rapid prototyping or a combination of the rapid prototyping and a conventional flasking technique. This allows different colors to be used to represent gingival and teeth colors in one operation, using the colors from the rapid prototyping, which are derived from the model.

The present disclosure relates to the art and science of dental prosthetics whereby dental professionals can produce a high quality complete denture at a substantially reduced cost, and in a reduced time, by using newly invented devices and software. It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A dental tracing apparatus comprising:
a first layer having a first surface and a second surface, wherein the second surface is coated with an adhesive material;
a second layer over the first surface of the first layer, wherein an edge portion of the second layer is substantially firmly attached to an edge portion of the first surface such that the second layer can be lifted off the first surface while the edge portion of the second layer is attached to the first surface; and
a removable third layer over the second surface of the first layer,
wherein:
the dental tracing apparatus is sized and shaped to be attached to a surface of a dental tray that is insertable into a mouth of a subject after the third layer is separated from the second surface of the first layer;
the dental tracing apparatus is configured to receive first tracing by an object via the second layer such that the first tracing generated according to movement of the object is marked on the dental tracing apparatus;
the marked first tracing is removable by separating the second layer from the first surface of the first layer; and
the lifted second layer is repositionable on the first surface of the first layer to receive second tracing by the object.

2. The apparatus of claim 1, wherein the apparatus is a dental tracer for recording a centric relation.

3. The apparatus of claim 1, wherein the second layer comprises a transparent or semi-transparent film.

4. The apparatus of claim 3, wherein the first surface of the first layer is colored to contrast a color of the second layer.

5. The apparatus of claim 1, wherein the first layer is formed from paper.

6. The apparatus of claim 5, wherein the third layer is formed from paper.

7. A dental impression tray assembly kit, comprising:
an upper tray configured to receive impression material for taking a first impression of a patient's gum and sized to be inserted into the patient's mouth;
a lower tray comprising:
a first piece configured to receive impression material for taking a second impression of the patient's gum and sized to be inserted into the patient's mouth, wherein the first piece is curved at about a central portion to form a right end portion and a left end portion; and
a pair of second pieces detachably coupled to the first piece, a right piece of the pair of second pieces coupled to the right end portion of the first piece and a left piece of the pair of second pieces coupled to the left end portion of the first piece; and
a dental tracing apparatus comprising three layers.

8. The kit of claim 7, wherein:
the pair of second pieces are configured to fit over the patient's gum when the pair of second pieces are coupled to the first piece;
the second impression is obtainable after the first piece is inserted into the patient's mouth with the pair of second pieces attached;
the pair of second pieces are detachable from the first piece after the second impression is obtained, and the upper tray retaining the first impression and the first piece of the lower tray retaining the second impression are insertable together into the mouth to determine jaw relations comprising a vertical dimension and a centric relation; and
a gap formed between the upper tray retaining the first impression and the first piece of the lower tray retaining the second impression is sized to receive bite registration material to obtain a bite registration.

9. The kit of claim 8, wherein the upper tray comprises:
a third piece configured to measure the jaw relations of the patient's mouth along with the first piece of the lower tray,
wherein the third piece is sized to cover the patient's upper anterior gum and has a front portion and a rear portion.

10. The kit of claim 9, wherein the upper tray further comprises:
a fourth piece configured to be detachably coupled to the rear portion of the third piece,
wherein the first impression is obtained when the third piece is inserted into the patient's mouth with the fourth piece attached, and
wherein the fourth piece is configured to be detached from the third piece after obtaining the first impression, and the third piece retaining the first impression and the first piece of the lower tray retaining the second impression are inserted together into the mouth to determine the jaw relations.

11. The kit of claim 10, wherein the fourth piece of the upper tray is sized to cover a distal portion or the rest of the patient's upper gum when attached to the third piece.

12. The kit of claim 8, further comprising:
an intra-oral tracer that is configured to be detachably coupled to the first piece of the lower tray and inserted into the mouth to be placed between the upper tray and the first piece of the lower tray and to measure the vertical dimension and the centric relation,
wherein the centric relation is recorded using the dental tracing apparatus.

13. The kit of claim 12, wherein:
the intra-oral tracer comprises an adjusting member that is inserted through an adjusting member receiving portion formed at a middle portion of the intra-oral tracer;
the centric relation is recorded on the dental tracing apparatus according to movement of the adjusting member that is in contact with the dental tracing apparatus in the patient's mouth; and
the adjusting member is raised or lowered to determine the vertical dimension and to adjust a size of the gap for receiving the bite registration material.

14. The kit of claim 7, wherein the three layers of the dental tracing apparatus comprise:
a first layer having a first surface and a second surface, wherein the second surface is coated with an adhesive material;
a second layer over the first surface of the first layer, wherein an edge portion of the second layer is substantially firmly attached to an edge portion of the first surface such that the second layer can be separated from the first surface while the edge portion of the second layer is attached to the first surface; and
a removable third layer over the second surface of the first layer.

15. The kit of claim 14, wherein the dental tracing apparatus is sized and shaped to be attached to a surface of the upper tray that is insertable into the patient's mouth after the third layer is separated from the second surface of the first layer.

16. The kit of claim 14, further comprising an intra-oral tracer that is configured to be detachably coupled to the first piece of the lower tray and inserted into the mouth to be placed between the upper tray and the first piece of the lower tray and to measure the vertical dimension and the centric relation,
wherein:
the intra-oral tracer comprises an adjusting member that is inserted through an adjusting member receiving portion formed at a middle portion of the intra-oral tracer;
the dental tracing apparatus is configured to receive tracing generated according to movement of the adjusting member in the mouth; and
the centric relation is recorded on the dental tracing apparatus according to the movement of the adjusting member that is in contact with the second layer of the dental tracing apparatus in the mouth.

17. The kit of claim 14, wherein:
the tracing marked on the dental tracing apparatus is removable by separating the second layer from the first surface of the first layer; and
the lifted second layer is repositionable on the first surface of the first layer to receive further tracing according to movement of the adjusting member in the mouth.

18. The kit of claim 8, wherein the kit is configured to allow the bite registration and final gum impressions, comprising the first impression and the second impression, to be obtained during a patient's single visit to a dentist without requiring heat treatment of the upper tray and the lower tray.

19. A dental impression tray assembly comprising:
a lower tray comprising a first piece and a pair of second pieces detachably coupled to the first piece, wherein the first piece comprises a receiving structure and the pair of second pieces are shaped to fit over the patient's lower gum when the pair of second pieces are coupled to the first piece;
an upper tray comprising a third piece and a fourth piece configured to be detachably coupled to the third piece, wherein the third piece and the fourth piece are configured to be coupled and inserted together into a mouth of the patient;
an intra-oral tracer that is configured to be detachably coupled to the first piece of the lower tray via the receiving structure; and
a dental tracing apparatus comprising:
a first layer having a first surface and a second surface, wherein the second surface is coated with an adhesive material;
a second layer over the first surface of the first layer, wherein an edge portion of the second layer is substantially firmly attached to an edge portion of the first surface such that the second layer can be separated from the first surface while the edge portion of the second layer is attached to the first surface; and
a removable third layer over the second surface of the first layer,
wherein the dental tracing apparatus is attached to a bottom surface of the third piece of the upper tray via the second surface of the first layer after the third layer is separated from the dental tracing apparatus,
wherein the intra-oral tracer is shaped to form a hole at a middle portion and an adjustable member is inserted into the hole to be raised or lowered through the hole to determine a vertical dimension,
wherein an upper end of the adjustable member is configured to contact the second layer of the dental tracing apparatus over the first surface of the first layer when the third piece and the first piece with the intra-oral tracer attached thereto are inserted into the mouth together such that a centric relation is recorded on the dental tracing apparatus according to movement of the adjustable member in the mouth, and
wherein the first piece of the lower tray is sized to cover an anterior portion of the patient's lower gum and the pair of second pieces are sized to cover distal portions or the rest of the lower gum when attached to the first piece such that a size of the lower tray including the first piece and the pair of second pieces is fixed.

20. A dental impression tray assembly comprising:
a lower tray configured to receive impression material and comprising a first piece and a pair of second pieces,
wherein the first piece, which is substantially U-shaped, is sized and configured to fit over at least an anterior portion of the lower gum, the first piece comprising a receiving portion,
wherein each of the pair of second pieces, which is configured to be detachably coupled to a corresponding one of two end portions of the substantially U-shaped first piece, is sized and configured to fit over a posterior portion of the lower gum when the pair of second pieces are coupled to the first piece, and
wherein the first piece is configured to be inserted into a patient's mouth with the pair of second pieces attached or without the pair of second pieces attached;
an upper tray configured to receive impression material and comprising a third piece and a fourth piece,
wherein the third piece is sized and configured to fit over at least an anterior portion of the upper gum,
wherein the fourth piece, which is detachably coupled to the third piece, is sized and configured to fit over a posterior portion of the upper gum, and
wherein the third piece is configured to be inserted into the patient's mouth with the fourth piece attached or without the fourth piece attached;
an intra-oral tracer that is configured to be detachably coupled to the first piece of the lower tray, the intra-oral tracer comprising an edge portion that is inserted into the receiving portion of the first piece,
wherein the intra-oral tracer is coupled to the first piece such that an open space of the U-shaped area is substantially covered by the intra-oral tracer,
wherein the intra-oral tracer is shaped to form a hole and comprises a pin that is inserted through the hole to be raised or lowered through the hole,
wherein a size of the lower tray including the first piece and the pair of second pieces and a size of the upper tray including the third piece and the fourth piece are fixed, and
wherein the first piece of the lower tray with the intra-oral tray attached and the third piece of the upper tray are sized and configured to be inserted together into the mouth to determine jaw relations comprising a vertical dimension and a centric relation; and
the dental tracing apparatus of claim 1 configured to record the centric relation in response to movement of the pin when the third piece of the upper tray and the first piece of the lower tray with the intra-oral tracer attached thereto are in the mouth.
